(19) United States
(12) Patent Application Publication
(10) Pub. No.: US 2002/0008571 A1
(43) Pub. Date: Jan. 24, 2002

(54) Apparatus for current pulse generation in voltage down converters

(76) Inventor: Oliver Weinfurtner, Fishkill (DE)

Correspondence Address: Frank Chau, Esq., F. CHAU & ASSOCIATES, LLP, 1900 Hempstead Turnpike, Suite 501, East Meadow, NY, 11554, US

(21) Appl. No.: 09/537,811

(22) Filed: Feb. 28, 2000

Related U.S. Application Data
(62) Division of application No. 08/937,763, filed on Sep. 25, 1997, now abandoned.

(51) Int. Cl. G05F 1/10

(52) U.S. Cl. 327/541

(57) ABSTRACT

A voltage converter circuit for an electronic device includes a transistor switch (140) for providing current pulses to a current input node. The transistor switch has a gate (128) and a turn-on threshold voltage. An adjustment circuit (114) provides a controlled voltage to the gate for turning on the transistor switch and the adjustment circuit includes a subcircuit for compensating for variations in the turn-on threshold voltage of the transistor switch. A timer (16) for enables the adjustment circuit for a preset period of time.

### BACKGROUND

1. Technical Field

This disclosure relates to electronic circuits and more particularly, to an adjustment circuit for a MOSFET switch.

2. Description of the Related Art

Generally, a semiconductor memory device comprises memory blocks for storing a plurality of binary information and memory peripheral circuits for driving the memory blocks. The memory device further comprises at least one voltage down converter for converting a supply voltage from an external power supply circuit to a desired level and supplying the converting voltage to an internal circuit which includes the memory blocks and the memory peripheral circuits. This down converting is necessary to ensure the reliability of the transistors by providing a lower power of operation.

Since components in the semiconductor device are micronized (generally about 0.5 microns or less), the reliability of the transistors would be greatly reduced if the full supply voltage were used to drive them. Reliability problems would arise in the form of break-down of insulating films of metal oxide semiconductor field effect transistors (MOSFET's).

A simple and area efficient way to create current pulses in voltage down converters is to use a MOSFET switch that is controlled by a timer circuit. Referring to FIG. 1, a prior art scheme is shown for a voltage down converter. MOSFET switch 2 has its source and drain connected between supply voltage Vₛᵤₚ and bit line high voltage V_{blh}. MOSFET switch 2 is controlled by a timer circuit 4. Generally, MOSFET switch 2 is synchronized with sense amplifiers 6 through timer circuit 4. Timer circuit 4 turns on MOSFET switch 2 for a preset amount of time. This allows a fixed amount of charge to flow from node Vₛᵤₚ to node V_{blh}. The sense amplifiers 6 sense a voltage differential between two complementary bit lines 8 of the memory block. When a difference is sensed by a sense amplifier, one of the two bit lines is brought high and the other is brought low. Low is generally ground potential where as high is Vblh. Ideally the amount of charge that flows through MOSFET switch 2 is identical to the amount of charge consumed by sense amplifiers 6 during the activation period.

The disadvantage of this scheme is the strong dependency of the transistor current on the parameters of the circuit, especially the threshold voltage of the MOSFET switch 2. A variation of V_{T} has a major influence on the current that is produced by the MOSFET switch 2.

Threshold voltage of a transistor is a function of many parameters including manufacturing processes, doping levels for the sources and drains, etc. In order to reduce the effects of threshold voltage variations on MOSFET switches it is necessary to compensate for these parameters. Thus, a need exists for an improved circuit which can account for variations in the threshold voltage of a MOSFET switch.

### SUMMARY OF THE INVENTION

A voltage converter circuit for an electronic device includes a transistor switch for providing current pulses to a current input node. The transistor switch has a gate and a turn-on threshold voltage. An adjustment circuit provides a controlled voltage to the gate for turning on the transistor switch and the adjustment circuit includes means for compensating for variations in the turn-on threshold voltage of the transistor switch. A timer for enables the adjustment circuit for a preset period of time.

In one embodiment, the transistor switch is a metal oxide semiconductor field effect transistor (MOSFET). In another embodiment, the adjustment circuit contains a transistor having a threshold voltage substantially equal to the threshold voltage of the transistor switch. The adjustment circuit may also include a voltage divider circuit. The voltage divider circuit has at least one resistor which can be dimensioned to adjust the gate voltage of the transistor switch. In another embodiment, the voltage divider circuit includes at least one transistor having a threshold voltage substantially the same as the transistor switch.

An adjustment circuit for a semiconductor memory devices includes a first node, a second node for connecting to a gate of a MOSFET switch and a feedback circuit connected to the first and second nodes for monitoring voltage changes at the first node and adjusting voltage at a second node to compensate for variations in current flow through the MOSFET switch. In an alternate embodiment, the feedback circuit further includes a differential amplifier to supply a substantially constant voltage to the first node, a resistor connected between the first node and ground such that a constant current flows through a first transistor, the first transistor having a gate connected to the second node. The first transistor and the MOSFET switch can both be either PMOSFET's or NMOSFET's with a threshold voltage substantially equal to the threshold voltage of the MOSFET switch.

### BRIEF DESCRIPTION OF DRAWINGS

Various embodiments will be described in detail in the following description of preferred embodiments with reference to the following figures wherein:

FIG. 1 shows a schematic diagram of a prior art MOSFET switch that is controlled by a timer circuit;

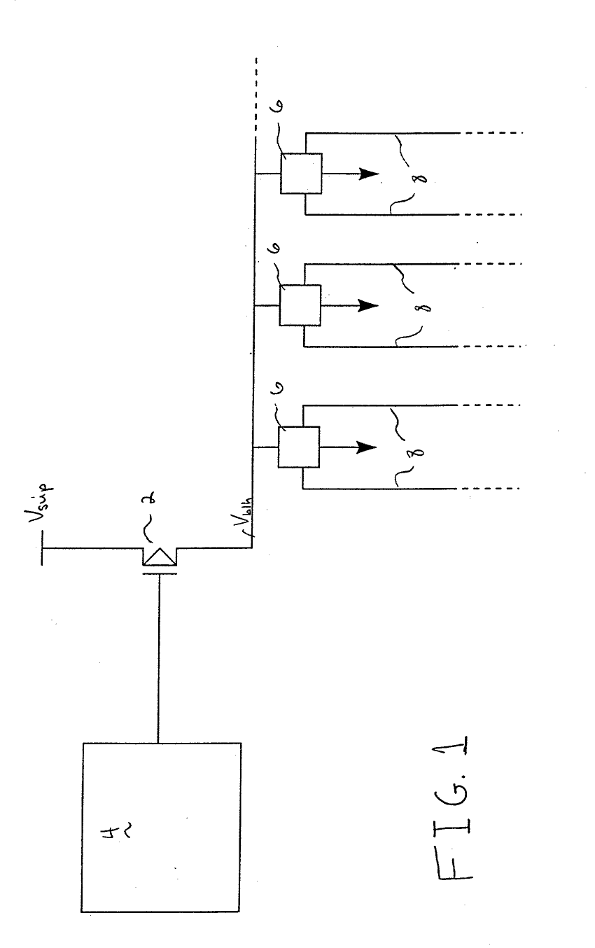

FIG. 2 shows a schematic/block diagram of an adjustment circuit enabled by a timer circuit and connected to a MOSFET switch;

FIG. 3 is a schematic diagram of an embodiment of an adjustment circuit connected to a MOSFET switch;

FIG. 4 is a schematic diagram of an alternate embodiment of the embodiment shown in FIG. 3 showing a plurality of transistors in series added to an adjustment circuit; and

FIG. 5 is a schematic diagram of another embodiment of an adjustment circuit showing a differential amplifier and a feedback loop used in conjunction with a MOSFET switch.

### DETAILED DESCRIPTION OF THE INVENTION

The present disclosure describes an adjustment circuit for minimizing effects due to the threshold voltage variations for a metal oxide semiconductor field effect transistor (MOSFET) switch. The MOSFET switch includes a timer for closing the switch for a preset period of time. This is useful for applications such as when sense amplifiers of a dynamic random access memory (DRAM) chip sense a differential voltage between a corresponding pair of bit lines. The switch connects between the supply voltage node and a bit line high voltage node. When the switch is activated current flows through the switch to sense amplifiers which are connected to complementary pairs of bit lines.

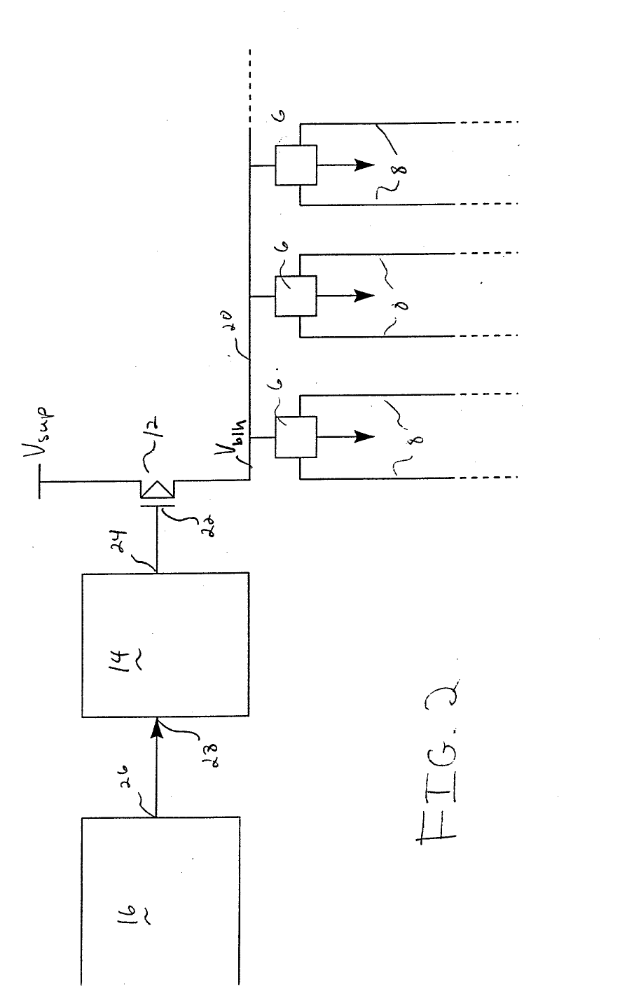

Referring now in specific detail to the drawings in which like reference numerals identify similar or identical elements throughout the several views, and initially to FIG. 2, a block diagram of a circuit of the present invention is shown. A timer circuit 16 sends a signal from a timer output 26. An adjustment circuit 14 is connected to timer output 26 at adjustment circuit input 28. The signal from output 26 enables adjustment circuit 14. Adjustment circuit 14 adjusts the voltage to an adjustment circuit output 24. A MOSFET switch 12 has a gate 22 connected to adjustment circuit output 24. When the adjusted voltage is applied to gate 22, current flows through switch 12 into the V_{blh} node. V_{blh} supplies sense amplifiers 6 to drive one of the complementary pair of bit lines 8 high. Adjustment circuit 14 is designed to provide gate 22 with appropriate voltage to allow a predetermined amount of current flow through MOSFET switch 12 to provide enough current to sense amplifiers 6 during activation. Although shown as a PMOSFET, MOSFET switch may also be an NMOSFET.

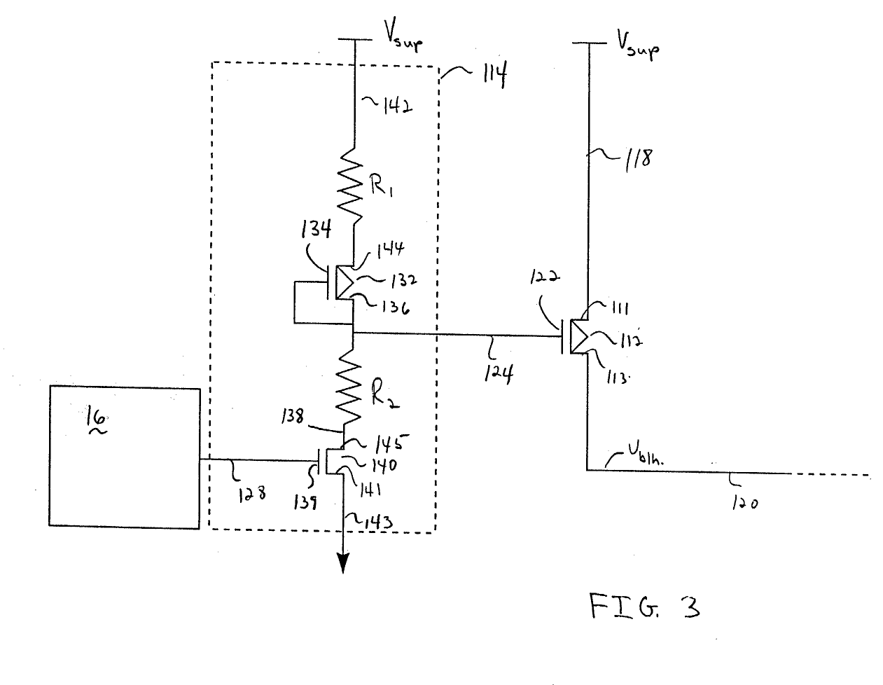

Referring to FIG. 3, an adjustment circuit 14 in accordance with one embodiment of the invention is schematically illustrated. Adjustment circuit 114 has an input 128 from a timer circuit 16. Input 128 is connected to a gate 139 of a transistor 140, for example a MOSFET. Transistor 140 acts as an activation switch-for the adjustment circuit 114. When the appropriate signal is received from-timer circuit 16, gate 128 is activated allowing current to flow through transistor 140. Transistor 140 has its drain 141 connected to ground 143 and its source 145 connected to node 138. A resistor R₂ is connected between node 138 and a node 124. Node 124 is connected to a transistor 132, preferable a PMOSFET. Transistor 132 has a source 144, a gate 134 and a drain 136. Both gate 134 and drain 136 are connected to node 124. Resistor R₁ connects between source 144 of transistor 132 and a node 142. Node 142 is at the supply voltage Vₛᵤₚ potential.

Node 124 is connected to a gate 122 of a transistor switch 112. Transistor switch 112 is preferably a MOSFET. Transistor switch has a source 111 and a drain 113. Drain 113 is connected to V_{blh} node, and source is connected to node 118 which remains at the supply voltage Vₛᵤₚ potential. It is preferred to have switch 112 be of the same kind as transistor 134, i.e. both of the transistors are PMOSFET's or both of the transistors are NMOSFET's. Preferably, transistor 134 and transistor switch 112 can share the same doped regions for their respective sources and drains. In this way the threshold voltage V_{T} across the transistor (the voltage difference between the source and drain of a transistor) is the same for both transistor 132 and transistor switch 112.

The resistors R₁ and R₂ and transistor 132 act as a voltage divider circuit. Timer circuit 16 sends an enable signal to input 128 which applies a voltage to gate 139. This allows current to flow from node 138 to ground 143. This current draw causes current flow through resistor R₁ creating a potential drop across the resistor R₁. This voltage is applied to gate 134 of transistor 132 allowing current to flow through resistor R₂ as well. The voltage at node 124 can be calculated as follows:

$${V}_{node 124} = \frac{{V}_{sup} - {V}_{T}}{{R}_{1} + {R}_{2}} \times {R}_{2}$$

V_{node 124} is the applied voltage to gate 122. The voltage that is applied to the gate is sufficient to allow current to flow from source 111 to drain 113. It is important that the charging current that passes through switch 112 be sufficient to enable operation of the sense amplifiers during their activation period. As such, the voltage that is applied to the gate is sufficiently high to achieve this goal. Since transistor 132 and switch 112 share the same doped regions for their respective sources and drains, any threshold voltage V_{T} changes across the transistors are the same. If, for example, the threshold voltage V_{T} of transistor 134 and switch 112 is increased, than their current flow from source to drain decreases. Consequently, the voltage at node 124 changes according to the formula:

$${V}_{node 124} + delta {V}_{node 124} \frac{{V}_{sup} - ( {V}_{T} + delta {V}_{T} )}{{R}_{1} + {R}_{2}} \times {R}_{2}$$

where:

delta V_{node 124} represents the change voltage differential from the voltage prior to the increased threshold voltage V_{T}; and

delta V_{T} represents the increase in threshold voltage V_{T} across the transistors.

The gate voltage of switch 112 is decreased and by this, the current flow from source 111 to drain 113 is increased. The combination of these two effects leads to reduced influence of the threshold voltage variations on the current flow through switch 112. The value of the voltage V_{node 124} can be controlled by dimensioning the resistors R₁ and R₂.

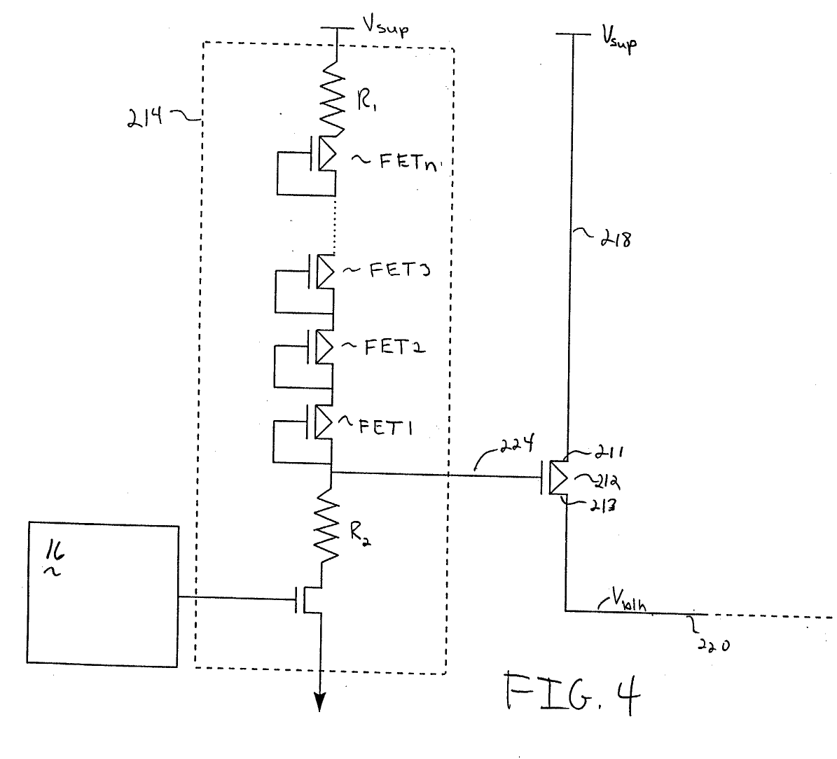

Referring to FIG. 4, another embodiment of the adjustment circuit includes the addition of transistors to further reduce the influence of threshold voltage changes on switch 112. A plurality of transistors designated as FET1 through FETn are connected serially between resistor R₁ and node 224. Each transistor is preferably the same type as a transistor switch 212, i.e. all transistors are PMOSFET's, or all NMOSFET's. Each of the plurality of transistors FET1 through FETn has its drain connected to its gate. It is preferred to have all the sources and drains of the transistors FET1 through FETn share the same doped regions for their respective sources and drains so that any threshold voltage V_{T} changes across the transistors are the same for each transistor. The compensation effect on switch 212 is increased. This means that the voltage at node 224 is more reliably achieved making the current flow rate through switch 224 more efficient and repeatable. If n is used to denote the number of transistors used, the voltage at node 224 can be calculated according to the following formula:

$${V}_{node 224} + delta {V}_{node 224} = \frac{{V}_{sup} - ( {V}_{T} + ( n \times delta {V}_{T} ) )}{{R}_{1} + {R}_{2}} \times {R}_{2}$$

where:

delta V_{node 224} represents the change voltage differential from the voltage prior to the increased threshold voltage V_{T};

n is the number of transistors introduced in series; and

delta V_{T} represents the increase in threshold voltage V_{T} across the transistors.

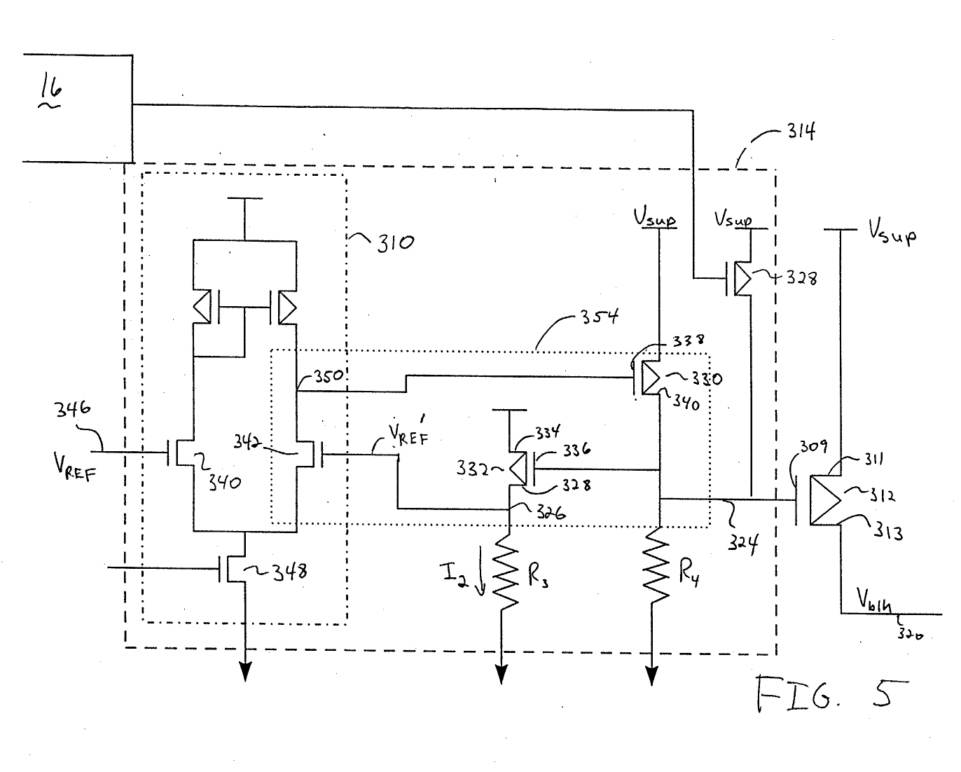

Referring to FIG. 5, another embodiment of an adjustment circuit 314 includes a two stage differential amplifier 310. An input 346 to differential amplifier 310 is at reference voltage V_{REF}. Differential amplifier 310 maintains voltage V_{REF}′ at a node 326. A feedback circuit 354 includes a transistor 342 of differential amplifier 310, a transistor 332, a transistor 330 and node 352, node 326 and node 324. Since the voltage at node 326 is held constant by differential amplifier 310, the current through resistor R₃ is constant. I₂=V_{REF}′/R₃.

Transistor 332 is used to track changes in threshold voltage V_{T} and adjusts the voltage in node 324 accordingly. Transistor 332 has a source 334, gate 336 and a drain 328. Drain 328 is connected to node 326 and gate 336 is connected to node 324. Transistor 330 connects node 352 to node 324 to complete feedback circuit 354. Transistor 330 has its gate 338 connected to node 352 and its drain 340 connected to node 324. If, for example, the threshold voltage of transistor 332 increases, the voltage at node 324 is lowered in order to maintain the constant voltage V_{REF}′ at node 326 (I₂=V_{REF}′/R₃). Feedback loop 354 adjusts the voltage of gate 336 to maintain I₂ constant. This means that the voltage at node 324 is compensated for variations in the threshold voltage in transistor 332, maintaining a predetermined voltage at node 324. Resistor R₄ keeps the voltage at node 324 regulated by allowing current form transistor 330 to flow to ground.

Transistors 332 and transistor switch 312 are of the same type, i.e. all PMOSFET's, or all NMOSFET's. So that tracking threshold voltage variations can be achieved in switch 312. It is preferred that transistor 332 and transistor switch 312 are made to share the same doped region of the chip. It is desired to achieve similar current densities in transistor 332 and transistor switch 312. The transition voltages would therefore be nearly the same for these transistors, hence threshold voltage variations can be more closely tracked.

A transistor 328 receives an enable signal from timer circuit 16 begins the activation cycle in which current flows through transistor switch 312 from Vₛᵤₚ. Node 324 is connected to a gate 309 of switch 312. This allows current to flow from Vₛᵤₚ toward V_{blh}. Since the voltage at node 324 is compensated, effects due variations in threshold voltages are minimized, thereby improving the performance and efficiency of switch 312.

While this invention has been described in terms of several illustrative embodiments, there are alterations, permutations, and equivalents which fall within the scope of this invention. It should also be noted that there are many alternative ways of implementing the processes of the present invention. It is therefore intended that the following appended claims be interpreted as including all such alterations, permutations, and equivalents as fall within the true spirit and scope of the present invention.

What is claimed is:

1. A voltage converter circuit comprising:
a transistor switch for providing current pulses to a current input node, the transistor switch having a gate and a turn-on threshold voltage;
an adjustment circuit for providing a controlled voltage to the gate for turning on the transistor switch and having means for compensating for variations in the turn-on threshold voltage of the transistor switch; and
a timer for enabling the adjustment circuit for a preset period of time.

2. The voltage converter circuit as recited in claim 1 wherein the transistor switch is a MOSFET.

3. The voltage converter circuit as recited in claim 1 wherein the adjustment circuit contains a transistor having a turn-on threshold voltage substantially equal to the turn-on threshold voltage of the transistor switch.

4. The voltage converter circuit as recited in claim 1 wherein the adjustment circuit includes a voltage divider circuit.

5. The voltage converter circuit as recited in claim 4 wherein the voltage divider circuit has at least one resistor which can be dimensioned to adjust the gate voltage of the transistor switch.

6. The voltage converter circuit as recited in claim 4 wherein the voltage divider circuit includes at least one transistor having a threshold voltage substantially the same as the transistor switch.

7. The voltage converter circuit as recited in claim 4 wherein the voltage divider circuit includes at least one transistor having a source and a drain, and the transistor switch has a source and a drain wherein the sources and drains share doped regions.

8. A semiconductor memory comprising an adjustment current, wherein the adjustment comprises:
a first node;
a second node for connecting to a gate of a MOSFET switch;
a feedback circuit connected to the first and second nodes for monitoring voltage changes at the first node and adjusting voltage at a second node to compensate for variations in current flow through the MOSFET switch.

9. The semiconductor memory as recited in claim 8 wherein the feedback circuit further comprises a differential amplifier to supply a substantially constant voltage to the first node, a resistor connected between the first node and ground such that a constant current flows through a first transistor, the first transistor having a gate connected to the second node.

10. The semiconductor memory as recited in claim 9 wherein the first transistor and the MOSFET switch are PMOSFETs.

11. The semiconductor memory as recited in claim 9 wherein the first transistor and the MOSFET switch are NMOSFETs.

12. The semiconductor memory as recited in claim 9 wherein the first transistor has a threshold voltage substantially equal to the threshold voltage of the MOSFET switch.

13. The semiconductor memory as recited in claim 9 wherein the first transistor has a source and a drain, the MOSFET switch has a source and a drain wherein the sources and drains share doped regions.

14. A semiconductor memory device voltage down converter comprising:
a first node having a reference voltage supplied thereto by a differential amplifier;
a first transistor having a gate connected to a second node, the second node connecting to a gate of a MOSFET switch;
a first resistor connecting between a drain of the first transistor and ground such that constant current flows through the first resistor and the first transistor;
a feedback circuit for monitoring voltage changes at the first node and adjusting voltage at a second node to compensate for variations in the threshold voltage of the MOSFET switch.

15. The semiconductor memory device voltage down converter as recited in claim 14 wherein the first transistor and the MOSFET switch are PMOSFETs.

16. The semiconductor memory device voltage down converter as recited in claim 14 wherein the first transistor and the MOSFET switch are NMOSFETs.

17. The semiconductor memory device voltage down converter as recited in claim 14 wherein the first transistor has a threshold voltage substantially equal to the threshold voltage of the MOSFET switch.

18. The semiconductor memory device voltage down converter as recited in claim 14 wherein the first transistor has a source and a drain, the MOSFET switch has a source and a drain wherein the sources and drains share doped regions.
